(19) United States
(12) Patent Application Publication
(10) Pub. No.: US 2022/0168650 A1
(43) Pub. Date: Jun. 2, 2022

(54) COMPUTER-READABLE RECORDING MEDIUM AND GAME SYSTEM

(71) Applicant: SQUARE ENIX CO., LTD., Tokyo (JP)

(72) Inventors: Shunnosuke ANDO, Tokyo (JP); Hiroaki OHNO, Tokyo (JP); Tsuyoshi YOKOZAWA, Tokyo (JP)

(73) Assignee: SQUARE ENIX CO., LTD., Tokyo (JP)

(21) Appl. No.: 17/456,027

(22) Filed: Nov. 22, 2021

(30) Foreign Application Priority Data
Nov. 27, 2020 (JP) 2020-197048

(51) Int. Cl. A63F 13/69; A63F 13/45; A63F 13/655; A63F 13/35; A63F 13/822

(52) U.S. Cl. CPC A63F 13/69; A63F 13/45; A63F 13/822; A63F 13/35; A63F 13/655

(57) ABSTRACT

A new game program that increases a degree of freedom of a player and provides a higher degree of satisfaction is provided.

A game program causes a game to be able to progress under a second mode having a lower degree of difficulty than a first mode in a case where a predetermined condition is satisfied.

### CROSS REFERENCE TO RELATED APPLICATION (S)

The present disclosure claims priority to Japanese Patent Application No. 2020-197048, filed on Nov. 27, 2020, the disclosure of which is expressly incorporated herein by reference in its entirety for any purpose.

### BACKGROUND

The present disclosure relates to a game program and a game system. In the related art, there is a massively multiplayer online role-playing game (MMORPG) in which in-game time that is common between a plurality of players elapses. In addition, there is a game in which a quest or a mission (hereinafter, referred to as the quest or the like) in the game is present, and a completion condition is determined for each quest or the like. Furthermore, there is a game in which an action not related to the completion condition can be executed during progress of the quest or the like.

### SUMMARY

However, the action not related to the completion condition is an act that increases time for completing the quest or the like or increases a possibility of incompletion, and generally bothers other players. In addition, the action may not be executed in a relaxed manner due to an enemy character or an obstacle that appears in the quest or the like.

A purpose of at least one embodiment of the present disclosure is to provide a new game program that increases a degree of freedom of a player and provide a higher degree of satisfaction.

According to a non-limiting aspect, the present disclosure is to provide a non-transitory computer-readable recording medium having recorded thereon a game program executed in a server apparatus of a game system including one or more terminal apparatuses operated by a player and the server apparatus connectable to the terminal apparatus by communication, the game program causing the server apparatus to function as first progress means for progressing a game under a first mode in a predetermined region in the game, second mode enabling means for enabling execution of a second mode in a case where a predetermined second mode execution condition for executing the second mode having a lower degree of difficulty than the first mode is satisfied, and second progress means for progressing the game under the second mode in the predetermined region.

According to a non-limiting aspect, the present disclosure is to provide a game system including one or more terminal apparatuses operated by a player and a server apparatus connectable to the terminal apparatus by communication, the game system including first progress means for progressing a game under a first mode in a predetermined region in the game, second mode enabling means for enabling execution of a second mode in a case where a predetermined second mode execution condition for executing the second mode having a lower degree of difficulty than the first mode is satisfied, and second progress means for progressing the game under the second mode in the predetermined region.

According to a non-limiting aspect, the present disclosure is to provide a non-transitory computer-readable recording medium having recorded thereon a game program executed in a terminal apparatus of a game system including one or more terminal apparatuses operated by a player and a server apparatus connectable to the terminal apparatus by communication, the game program causing the terminal apparatus to function as first progress means for progressing a game under a first mode in a predetermined region in the game, second mode enabling means for enabling execution of a second mode in a case where a predetermined second mode execution condition for executing the second mode having a lower degree of difficulty than the first mode is satisfied, and second progress means for progressing the game under the second mode in the predetermined region.

### BRIEF DESCRIPTION OF THE DRAWINGS

FIG. 1 is a block diagram illustrating a configuration of the server apparatus according to at least one embodiment of the present disclosure.

FIG. 2 is a flowchart of the program execution process according to at least one embodiment of the present disclosure.

FIG. 3 is a block diagram illustrating a configuration of the server apparatus according to at least one embodiment of the present disclosure.

FIG. 4 is a flowchart of the program execution process according to at least one embodiment of the present disclosure.

FIG. 5 is a block diagram illustrating a configuration of the system according to at least one embodiment of the present disclosure.

FIG. 6 is a flowchart of the program execution process according to at least one embodiment of the present disclosure.

FIG. 7 is a block diagram illustrating a configuration of the system according to at least one embodiment of the present disclosure.

FIG. 8 is a block diagram illustrating a configuration of the system according to at least one embodiment of the present disclosure.

FIG. 9 is a flowchart related to an execution process according to at least one embodiment of the present disclosure.

FIG. 10 is a flowchart related to the first mode execution process according to at least one embodiment of the present disclosure.

FIG. 11 is a diagram for describing a usable attribute master table according to at least one embodiment of the present disclosure.

FIG. 12 is a flowchart related to the second mode execution process according to at least one embodiment of the present disclosure.

### DESCRIPTION OF EMBODIMENTS

Hereinafter, embodiments of the disclosure will be described with reference to the accompanying drawings. Hereinafter, description relating to effects shows an aspect of the effects of the embodiments of the disclosure, and does not limit the effects. Further, the order of respective processes that form a flowchart described below may be changed in a range without contradicting or creating discord with the processing contents thereof.

### First Embodiment

A summary of a first embodiment of the present disclosure will be described. Hereinafter, as the first embodiment, a game program executed in a server apparatus of a game system including one or more terminal apparatuses operated by a player and the server apparatus connectable to the terminal apparatus by communication will be illustratively described.

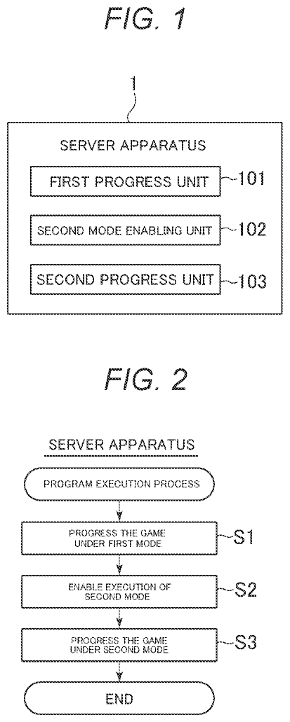

FIG. 1 is a block diagram illustrating a configuration of the server apparatus according to at least one embodiment of the present disclosure. A server apparatus 1 includes at least a first progress unit 101, a second mode enabling unit 102, and a second progress unit 103.

The first progress unit 101 has a function of progressing a game under a first mode in a predetermined region in the game. The second mode enabling unit 102 has a function of enabling execution of a second mode in a case where a predetermined second mode execution condition for executing the second mode having a lower degree of difficulty than the first mode is satisfied. The second progress unit 103 has a function of progressing the game under the second mode in the predetermined region.

Next, a program execution process in the first embodiment of the present disclosure will be described. FIG. 2 is a flowchart of the program execution process according to at least one embodiment of the present disclosure.

The server apparatus 1 progresses the game under the first mode in the predetermined region in the game (step S1). Next, in a case where the predetermined second mode execution condition for executing the second mode having a lower degree of difficulty than the first mode is satisfied, the server apparatus 1 enables execution of the second mode (step S2).

Next, the server apparatus 1 progresses the game under the second mode in the predetermined region in step S1 (step S3) and finishes the program execution process.

As one aspect of the first embodiment, a new game program that increases a degree of freedom of a player and provides a higher degree of satisfaction can be provided.

In the first embodiment, for example, the “terminal apparatus” refers to a stationary game console, a portable game console, a wearable terminal, a desktop or laptop personal computer, a tablet computer, or a PDA and may be a portable terminal such as a smartphone including a touch panel sensor on a display screen. For example, the “server apparatus” refers to an apparatus that executes a process in accordance with a request from the terminal apparatus.

In the first embodiment, for example, the “region” is an element constituting a part of a virtual world formed in the game and may have any size and shape. For example, the “degree of difficulty” refers to an index of difficulty of causing a progress status of the game to reach a predetermined state. For example, a “low degree of difficulty” refers to easiness of causing the progress status of the game to reach the predetermined state compared to a mode having a high degree of difficulty. For example, “enabling execution” refers to changing an inexecutable state to an executable state.

### Second Embodiment

Next, a summary of a second embodiment of the present disclosure will be described. Hereinafter, as the second embodiment, the game program executed in the server apparatus of the game system including one or more terminal apparatuses operated by the player and the server apparatus connectable to the terminal apparatus by communication will be illustratively described.

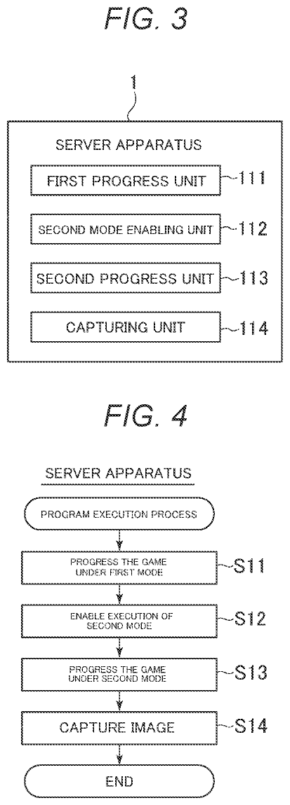

FIG. 3 is a block diagram illustrating a configuration of the server apparatus according to at least one embodiment of the present disclosure. The server apparatus 1 includes at least a first progress unit 111, a second mode enabling unit 112, a second progress unit 113, and a capturing unit 114.

The first progress unit 111 has a function of progressing the game under the first mode in the predetermined region in the game. The second mode enabling unit 112 has a function of enabling execution of the second mode in a case where the predetermined second mode execution condition for executing the second mode having a lower degree of difficulty than the first mode is satisfied.

The second progress unit 113 has a function of progressing the game under the second mode in the predetermined region. The capturing unit 114 has a function of capturing an image in the game based on an operation instruction of the player.

Next, the program execution process in the second embodiment of the present disclosure will be described. FIG. 4 is a flowchart of the program execution process according to at least one embodiment of the present disclosure.

The server apparatus 1 progresses the game under the first mode in the predetermined region in the game (step S11). Next, in a case where the predetermined second mode execution condition for executing the second mode having a lower degree of difficulty than the first mode is satisfied, the server apparatus 1 enables execution of the second mode (step S12).

Next, the server apparatus 1 progresses the game under the second mode in the predetermined region in step S11 (step S13). Next, the server apparatus 1 captures the image in the game based on the operation instruction of the player (step S14) and finishes the program execution process.

As one aspect of the second embodiment, a new game program that increases the degree of freedom of the player and provides a higher degree of satisfaction can be provided.

As one aspect of the second embodiment, a new image generation program of higher interest can be provided.

As one aspect of the second embodiment, by including the capturing unit, the game program that can capture the image in the game at a preferred angle of view of the player and provides a higher degree of satisfaction and interest can be provided.

In the second embodiment, contents disclosed in the first embodiment can be employed as necessary for each of the “terminal apparatus”, the “server apparatus”, the “region”, the “degree of difficulty”, the “low degree of difficulty”, and “enabling execution”.

In the second embodiment, for example, the “image in the game” refers to an image representing the progress status of the game. For example, the “image” is formed with a text, a figure, a symbol, a solid shape, or a color, or a combination thereof and may be a still picture or a motion picture.

### Third Embodiment

Next, a summary of a third embodiment of the present disclosure will be described. Hereinafter, as the third embodiment, the game program executed in the server apparatus of the game system including one or more terminal apparatuses operated by the player and the server apparatus connectable to the terminal apparatus by communication will be illustratively described.

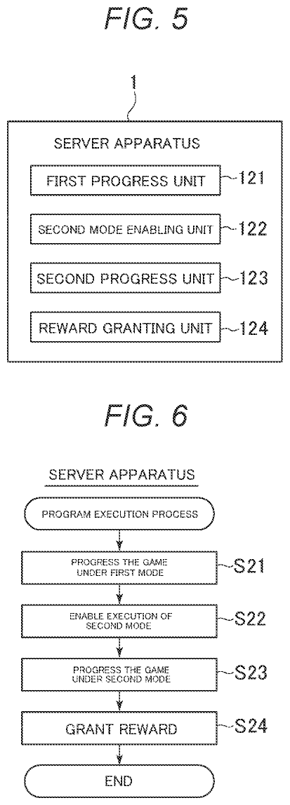

FIG. 5 is a block diagram illustrating a configuration of the server apparatus according to at least one embodiment of the present disclosure. The server apparatus 1 includes at least a first progress unit 121, a second mode enabling unit 122, a second progress unit 123, and a reward granting unit 124.

The first progress unit 121 has a function of progressing the game under the first mode in the predetermined region in the game. The second mode enabling unit 122 has a function of enabling execution of the second mode in a case where the predetermined second mode execution condition for executing the second mode having a lower degree of difficulty than the first mode is satisfied.

The second progress unit 123 has a function of progressing the game under the second mode in the predetermined region. The reward granting unit 124 has a function of granting a reward to the player in a case where a predetermined reward granting condition is satisfied.

It is preferable that the server apparatus 1 grants the reward by reward granting means under the first mode and does not grant the reward by the reward granting means under the second mode.

Next, the program execution process in the third embodiment of the present disclosure will be described. FIG. 6 is a flowchart of the program execution process according to at least one embodiment of the present disclosure.

The server apparatus 1 progresses the game under the first mode in the predetermined region in the game (step S21). Next, in a case where the predetermined second mode execution condition for executing the second mode having a lower degree of difficulty than the first mode is satisfied, the server apparatus 1 enables execution of the second mode (step S22).

Next, the server apparatus 1 progresses the game under the second mode in the predetermined region in step S21 (step S23). Next, in a case where the predetermined reward granting condition is satisfied, the server apparatus 1 grants the reward to the player (step S24) and finishes the program execution process.

Here, the server apparatus 1 performs a control for granting the reward by the reward granting unit 124 under the first mode and not granting the reward by the reward granting unit 124 under the second mode.

As one aspect of the third embodiment, a new game program that increases the degree of freedom of the player and provides a higher degree of satisfaction can be provided.

As one aspect of the third embodiment, by including the reward granting unit and performing the control as to whether or not to grant the reward in accordance with a mode of the game, a new game program that enables the player to select which mode to play and provides a high degree of freedom and a higher degree of satisfaction can be provided.

In the third embodiment, contents disclosed in the first embodiment can be employed as necessary for each of the “client terminal”, the “server apparatus”, the “three-dimensional virtual space”, the “image representing the progress status”, the “viewpoint coordinates”, the “viewpoint object”, the “object”, the “sight line direction”, the “first attribute”, and “independently of the instruction operation of the player”.

In the third embodiment, for example, the “reward” is granted to the player itself, an account corresponding to the player, or a game object corresponding to the player and provides advantage on progress of the game.

### Fourth Embodiment

Next, a summary of a fourth embodiment of the present disclosure will be described. Hereinafter, as the fourth embodiment, the game system including one or more terminal apparatuses operated by the player and the server apparatus connectable to the terminal apparatus by communication will be illustratively described.

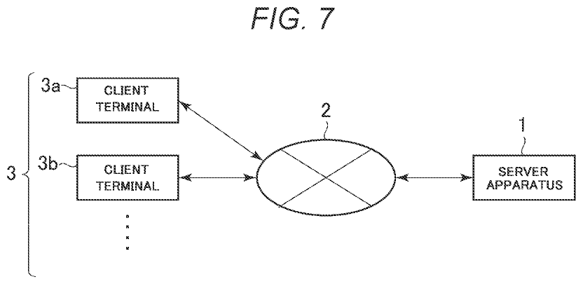

FIG. 7 is a block diagram illustrating a configuration of the system according to at least one embodiment of the present disclosure. As illustrated, the system is configured with a plurality of terminal apparatuses 3 (terminal apparatuses 3a, 3b, . . . ) operated by a plurality of users (users A, B, . . . ), a communication network 2, and the server apparatus 1. The terminal apparatuses 3 are connected to the server apparatus 1 through the communication network 2. The terminal apparatuses 3 and the server apparatus 1 may not be connected at all times, and the connection may be available as necessary.

The server apparatus 1 includes at least a control unit, a RAM, a storage unit, and a communication interface that are connected to each other through an internal bus. The control unit may include an internal timer. In addition, the control unit may synchronize with an external server using the communication interface. Accordingly, the real time may be acquired.

The server apparatus 1 may be divided into an application server apparatus and a WEB server apparatus. In this case, the WEB server apparatus may be installed to be connectable from at least one of the application server apparatus and the terminal apparatuses through the communication network.

As one example, each terminal apparatus 3 includes a control unit, a RAM, a storage unit, a sound processing unit, a graphics processing unit, a communication interface, and an interface unit that are connected to each other through an internal bus. The graphics processing unit is connected to a display unit. The display unit may include a display screen and a touch input unit that receives an input by contact of the player on the display unit.

For example, the touch input unit may be able to detect a position of contact using any methods such as a resistive film method, an electrostatic capacitive method, an ultrasonic surface acoustic wave method, an optical method, or an electromagnetic induction method used in a touch panel, and any method may be used as long as an operation can be recognized by a touch operation of a user. The touch input unit is a device that can detect a position of a finger or the like in a case where an operation such as push or movement is performed on an upper surface of the touch input unit with the finger, a stylus, or the like.

An external memory (for example, an SD card) may be connected to the interface unit. Data read from the external memory is loaded into the RAM, and a calculation process is executed on the data by the control unit.

The communication interface can be connected to the communication network in a wireless or wired manner and can receive data through the communication network. In the same manner as the data read from the external memory, data received through the communication interface is loaded into the RAM, and the calculation process is performed on the data by the control unit.

Each terminal apparatus 3 may include a sensor such as a proximity sensor, an infrared sensor, a gyro sensor, or an acceleration sensor. In addition, each terminal apparatus 3 may include an imaging unit that includes a lens and performs imaging through the lens. Furthermore, each terminal apparatus 3 may be a terminal apparatus that can be mounted (wearable) on a human body.

Summary of System

Next, a summary of the system assumed in the fourth embodiment of the present disclosure will be described. In the fourth embodiment, a game system of an MMORPG is exemplified as one example of the game system. In the MMORPG game time in the virtual world of the game elapses at all times in the server apparatus and does not depend on a connection status of the player. In addition, in a case where a plurality of terminal apparatuses are connected to the game world, the server apparatus may process an input process performed on each terminal apparatus in a real-time synchronous manner.

For example, a game in which a searchable region is set in advance in a field of the virtual world is exemplified as one example of the MMORPG of the fourth embodiment. In a case where an object (hereinafter, referred to as a player object) that acts based on the operation instruction of the player moves in the region, performs a search, and satisfies a predetermined completion condition, the search is considered successful, and the game in the region is completed. The region may be referred to as a quest, a mission, a dungeon, a map, or a stage in other words.

In the region, for example, an enemy object that performs a virtual battle with the player object may be present. In addition, in the region, for example, a mechanism (gimmick) that hinders the player object from satisfying the predetermined completion condition may be installed.

A method of defeating the enemy object, using an item, executing an input operation on an object such as a switch arranged in the region, or opening a way ahead based on a predetermined action of the player object is exemplified as one example of the mechanism. In addition, a method of hindering the progress of the game such as attacking the player object from outside the region is exemplified.

In the MMORPG of the fourth embodiment, an object attribute may be set as an attribute of the player object. For example, a level, a job, or an ability is exemplified as the object attribute. In addition, the player object has a predetermined ability. For example, the ability may generate an effect of attack, defense, recovery, buff, and debuff in the region.

In addition, an item attribute may be set as an attribute of the item usable in the game. For example, a level, a degree of training, or durability is exemplified as the item attribute.

In addition, as one example of the game system, for example, a party may be able to be formed with an object (hereinafter, referred to as another player object) corresponding to an operation instruction of another player. In a case of infiltrating into the predetermined region, forming the party may be required.

Furthermore, as the game system, the image in the game may be able to be captured based on the operation instruction of the player. The captured image may be uploaded to the WEB server and published on the Internet.

Functional Description

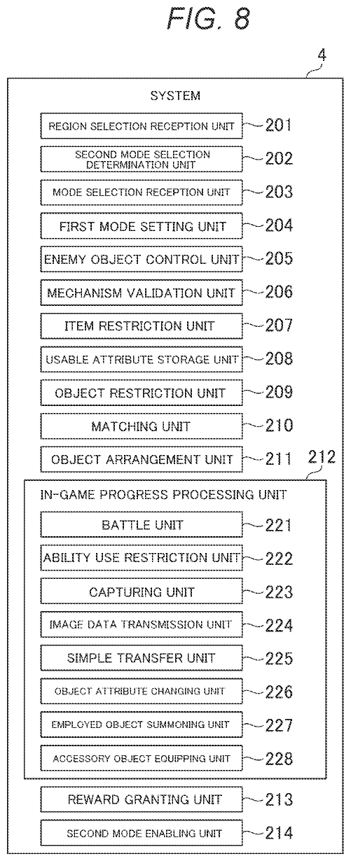

Functions of a system 4 will be described. FIG. 8 is a block diagram illustrating a configuration of the system according to at least one embodiment of the present disclosure.

The system 4 may include a region selection reception unit 201, a second mode selection determination unit 202, a mode selection reception unit 203, a first mode setting unit 204, an enemy object control unit 205, a mechanism validation unit 206, an item restriction unit 207, a usable attribute storage unit 208, an object restriction unit 209, a matching unit 210, an object arrangement unit 211, an in-game progress processing unit 212, a reward granting unit 213, and a second mode enabling unit 214.

The region selection reception unit 201 has a function of receiving selection of a region in which the player plays. The second mode selection determination unit 202 has a function of determining whether or not a mode selection condition is satisfied and mode selection is enabled. The mode selection reception unit 203 has a function of receiving a mode selected by the player. The first mode setting unit 204 has a function of setting the first mode as the selected mode.

The enemy object control unit 205 has a function of causing the enemy object performing the virtual battle with the player object to appear in the game. The mechanism validation unit 206 has a function of validating the mechanism set in advance in the region. The item restriction unit 207 has a function of restricting use of an item of which the item attribute does not satisfy a predetermined item use condition. The usable attribute storage unit 208 has a function of storing the attribute of the object usable in the region in association with the region.

The object restriction unit 209 has a function of restricting use of an object in a case where a predetermined attribute related to the object does not satisfy a predetermined object use condition. The matching unit 210 has a function of performing a matching process between objects operable by the player.

The object arrangement unit 211 has a function of arranging an arranged object that is a target on which the object operable by the player executes a predetermined action. The in-game progress processing unit 212 has a function of executing a process in the progress of the game.

The reward granting unit 213 has a function of granting the reward to the player in a case where the predetermined reward granting condition is satisfied. The second mode enabling unit 214 has a function of enabling execution of the second mode in a case where the predetermined second mode execution condition for executing the second mode having a lower degree of difficulty than the first mode is satisfied.

The in-game progress processing unit 212 may include a battle unit 221, an ability use restriction unit 222, a capturing unit 223, an image data transmission unit 224, a simple transfer unit 225, an object attribute changing unit 226, an employed object summoning unit 227, and an accessory object equipping unit 228.

The battle unit 221 has a function of performing the virtual battle with the enemy object. The ability use restriction unit 222 has a function of restricting use of the ability in a case where a predetermined ability use condition is not satisfied. The capturing unit 223 has a function of capturing the image in the game based on the operation instruction of the player. The image data transmission unit 224 has a function of transmitting image data captured by the capturing unit 223 to the server apparatus.

The simple transfer unit 225 has a function of transferring the player object to a predetermined location in the region in a case where a predetermined reaching condition is satisfied. The object attribute changing unit 226 has a function of changing the object attribute to another predetermined attribute in accordance with the operation instruction of the player.

The employed object summoning unit 227 has a function of causing an employed object employable by the player object to appear in accordance with the operation instruction of the player. The accessory object equipping unit 228 has a function of equipping the player object with a mountable accessory object in accordance with the operation instruction of the player.

Execution Process Flow

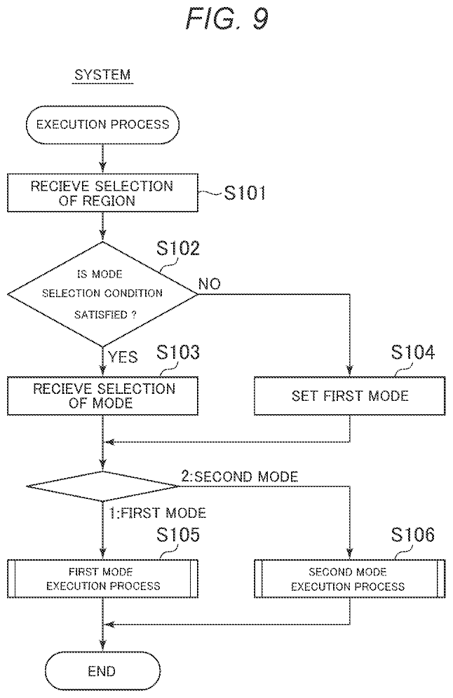

Next, one example of a process of the game executed in the system 4 will be described using a flowchart. FIG. 9 is a flowchart related to an execution process according to at least one embodiment of the present disclosure. Here, the game executed in the system 4 may be a game in which the player object operated by the player proceeds alone, or may be a game in which the player object proceeds as the party formed in advance with the other player object operated by the other player.

First, the system 4 receives selection of the region in which the player desires to play (step S101). The region may be able to be selected in a case where the player object is not playing the game in the region.

Next, the system 4 determines whether or not the mode selection condition is satisfied and mode selection is enabled (step S102). Specifically, the determination may be performed by determining whether or not the region selected in step S101 is completed.

In a case where the mode selection condition is not satisfied (NO in step S102), the system 4 sets the first mode as the selected mode (step S104). Meanwhile, in a case where the mode selection condition is satisfied (YES in step S102), the system 4 receives the mode selected by the player (step S103).

In a case where the selected mode is “1: first mode”, the system 4 executes a first mode execution process (step S105) and finishes the execution process. In a case where the selected mode is “2: second mode”, a second mode execution process is executed (step S106), and the execution process is finished. Here, the finish is a finish of the progress of the game related to the selected region.

First Mode Execution Process

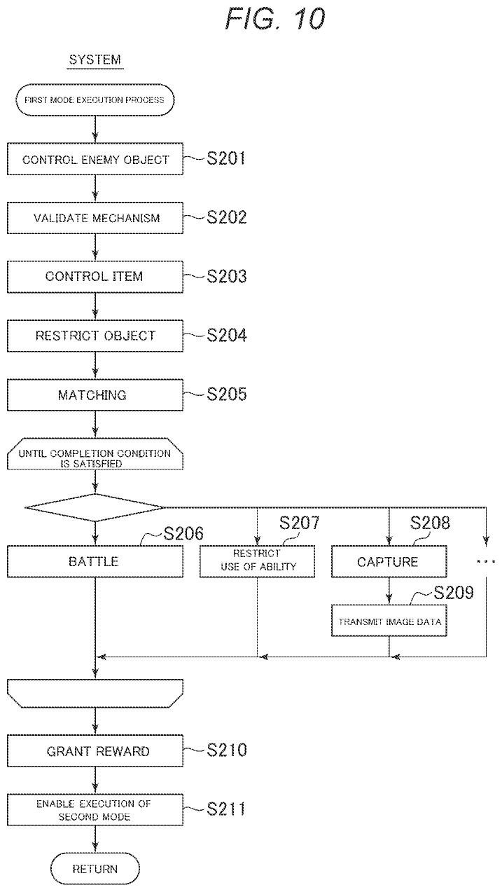

Next, one example of the first mode execution process executed in the system 4 will be described using a flowchart. FIG. 10 is a flowchart related to the first mode execution process according to at least one embodiment of the present disclosure.

The system 4 causes the enemy object performing the virtual battle with the player object to appear in the game (step S201). Specifically, arrangement of the enemy object at a given position, random arrangement of the enemy object within a given range, or the like is exemplified. A rank (for example, a boss, a middle boss, or small fry) of the arranged enemy object may be determined at the arranged position.

Next, the system 4 validates the mechanism set in advance in the region (step S202). Validating the mechanism generates an effect of hindering the player object from proceeding ahead. As the number of mechanisms is increased in the region, it is more difficult (degree of difficulty is increased) for the player to seize the region.

Next, the system 4 restricts use of the item of which the item attribute does not satisfy the predetermined item use condition (step S203). For example, the level of the item is exemplified as the item attribute. As the level of the item is increased, an effect generated by using the item is increased.

A restriction on the level of the item that can be carried in the region may be imposed on the region. That is, in a region in which “item level is less than or equal to 25” is set, an item that does not satisfy the condition may not be able to be carried.

Next, in a case where the object attribute does not satisfy the object use condition in the region, the system 4 restricts use of the object (step S204). In a case where the object use condition is not satisfied, an error message may be displayed, or the player object may be automatically replaced by the system 4 in order to satisfy the object use condition.

Restriction of Use of Object

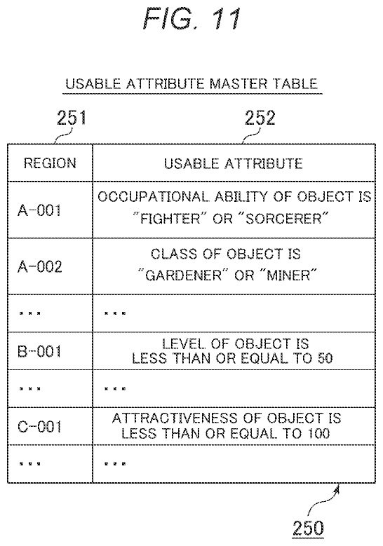

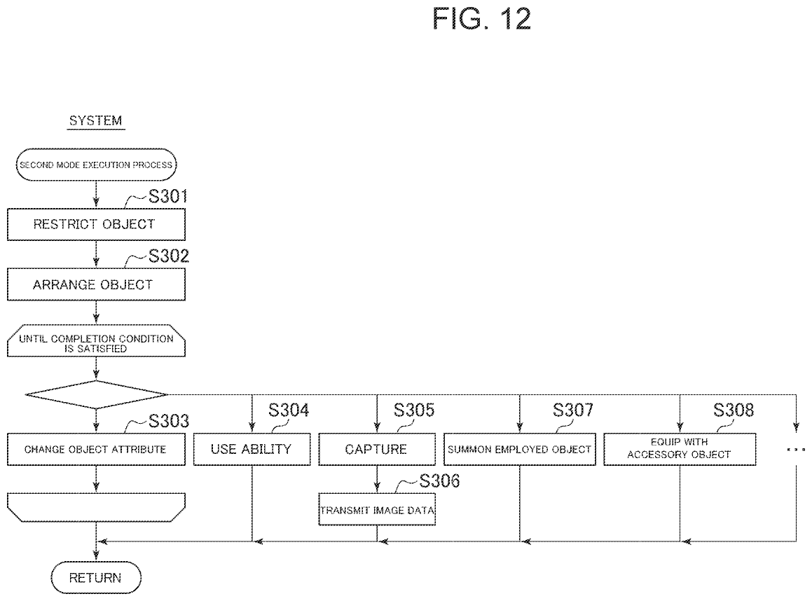

For example, restriction of use of the object may be implemented in association with the region by preparing master data in advance for the attribute of the object usable in the region. FIG. 11 is a diagram for describing a usable attribute master table according to at least one embodiment of the present disclosure.

In a usable attribute master table 250, at least a usable attribute 252 may be stored in association with a region 251. The region 251 is a region that may be selected by the player. The usable attribute 252 indicates the player object that can play the game in the region, or a condition for the player object. For example, the condition is exemplified such that an occupation (a function, a job, a class, or the like) of the player object is a predetermined occupation, the level of the object is less than or equal to a predetermined value, or a predetermined status of the object is less than or equal to a predetermined value.

FIG. 10 will be referred to again. The system 4 executes the matching process between the player objects (step S205). In a case of challenging for the region, a participation condition different from restriction of use of the object may be imposed. For example, the participation condition is such that minimum one player object of the predetermined occupation is included. In order to satisfy the participation condition, the matching process with the other player object is executed.

The matching process may be matching with the other player object in order to satisfy the participation condition. In addition, matching with the other player object having an attribute of a value close to the attribute (for example, the level) of the player object may be performed. Any algorithm can be used as a matching algorithm.

The process of step S201 to step S205 is a process executed in a stage before the game play in the region and may be executed in any order.

Next, the system 4 executes the process in the progress of the game in the region. The process in the progress of the game is executed in accordance with an input instruction of the player and is executed until the completion condition is satisfied.

Battle Process

The system 4 performs the virtual battle between the player object and the enemy object in accordance with the input instruction of the player (step S206). In a case where a predetermined winning condition is satisfied, the player object wins. In a case where a predetermined losing condition is satisfied, the player object loses.

Use of Ability

The system 4 determines whether or not the predetermined ability use condition is satisfied, and enables use of the ability of the player object in a case where the ability use condition is satisfied. Meanwhile, in a case where the ability use condition is not satisfied, use of the ability of the player object is restricted (step S207).

For example, a case where points accumulated in accordance with elapsed time of the game in the region exceeds a predetermined threshold, a case where points accumulated by attacking the enemy object exceeds a predetermined threshold, or a case where an amount of damage received from the enemy object or the mechanism exceeds a predetermined threshold is exemplified as the ability use condition.

Image Capturing

The system 4 captures the image in the game based on the operation instruction of the player (step S208). The image may be a still picture or a motion picture. Image data that can be visually recognized by the player may be captured, or image data of a game space seen from a viewpoint of the player object in the game space may be captured.

It is preferable that in-game time is not stopped during capturing. By not stopping the in-game time even in a case where capturing is performed by any player, the game can be progressed smoothly, and the degree of satisfaction of the player is improved.

The system 4 transmits the captured image data to the WEB server apparatus (step S209). The WEB server may be the server apparatus 1 in the system 4 or may be another server apparatus. In a case where the image data is received, the WEB server publishes the image data online in a visually recognizable manner. Users who can visually recognize the image data may be limited to the players of the game, or the image data may be widely and generally published.

The process in the progress of the game is not limited to the above process. Besides capturing, an action not related to the completion condition of the game, such as collecting an item, performing a geological survey, or cooking an ingredient, can be executed.

Simple Transfer

In a case where the predetermined reaching condition is satisfied, the system 4 may transfer the player object to the predetermined location in the region. For example, the reaching condition is exemplified such that a point (save point or the like) in the middle of the region is reached, or the middle boss is defeated. It is preferable that the location of a transfer destination is a location associated with the reaching condition or a location (for example, an entrance of the region) that improves convenience of the player.

Completion Condition

For example, the completion condition of the game is exemplified such that a predetermined enemy object in the region is defeated, a predetermined number of predetermined enemy objects are defeated, a predetermined quantity of predetermined items are collected, a predetermined item is obtained, or a predetermined position is reached.

In a case where the completion condition is satisfied, the system 4 grants the reward associated with the region to the player (step S210). It is preferable that the granted reward is usable in the game.

In a case where the completion condition is satisfied, the system 4 enables execution of the second mode (step S211). The mode selection condition in step S102 may be satisfied through the process of step S211. After executing the process of step S211, the system 4 finishes the first mode and finishes the search in the region.

Second Mode Execution Process

Next, one example of the second mode execution process executed in the system 4 will be described using a flowchart. FIG. 12 is a flowchart related to the second mode execution process according to at least one embodiment of the present disclosure.

In a case where the object attribute does not satisfy the object use condition in the region, the system 4 restricts use of the object (step S301). In a case where the object use condition is not satisfied, an error message may be displayed, or the player object may be automatically replaced by the system 4 in order to satisfy the object use condition.

The object use condition in the second mode can employ a content of the usable attribute master table illustrated in FIG. 11 to the necessary extent. In addition, it is preferable that the object use condition under the second mode is less restricted than under the first mode. For example, it is preferable that the usable attribute 252 is set to increase the number of objects usable in the second mode. That is, by increasing the number of usable player objects in the second mode compared to the first mode, seizing the region is facilitated, and the degree of difficulty can be decreased compared to the first mode.

Next, the system 4 arranges the arranged object that is the target on which the player object executes the predetermined action (step S302). For example, in a case where the player object attacks, the player object cannot attack in a case where an object that can be selected by the player is not present. Therefore, by arranging the arranged object, attack can be performed, or the ability can be used even at a location at which the enemy object is not present, and the degree of freedom of the player can be improved. Furthermore, by using the capturing unit, a more colorful image of a high degree of satisfaction can be captured.

The process of steps S301 and S302 is a process executed in the stage before the game play in the region, and the process may be in any order.

It is preferable that the second mode is less restricted than the first mode. That is, it is preferable that at least one of arrangement of the enemy object in step S201, validation of the mechanism in step S202, restriction of the item in step S203, and matching in step S205 is not implemented in the second mode. By doing so, the degree of freedom of the second mode is improved, and play that cannot be implemented under the first mode can be implemented.

Next, the system 4 executes the process in the progress of the game in the region. The process in the progress of the game is executed in accordance with the input instruction of the player and is executed until the completion condition is satisfied.

Change of Object Attribute

The system 4 changes the object attribute to the other predetermined attribute in accordance with the operation instruction of the player (step S303). It is preferable that the changeable object attribute is an attribute that may coincide with the usable attribute 252 in step S301.

Use of Ability

The system 4 uses the ability of the player object in accordance with the operation instruction of the player (step S304). In the second mode, unlike the first mode, a restriction may not be imposed on use of the ability. In this case, the player can use the ability at a preferred timing, and the degree of freedom of the second mode is improved.

Image Capturing

The system 4 captures the image in the game based on the operation instruction of the player (step S305). The image may be a still picture or a motion picture. The image data that can be visually recognized by the player may be captured, or the image data of the game space seen from the viewpoint of the player object in the game space may be captured.

It is preferable that the in-game time is not stopped during capturing. By not stopping the in-game time even in a case where capturing is performed by any player, the game can be progressed smoothly, and the degree of satisfaction of the player is improved.

The system 4 transmits the captured image data to the WEB server apparatus (step S306). The WEB server may be the server apparatus 1 in the system 4 or may be another server apparatus. In a case where the image data is received, the WEB server publishes the image data online in a visually recognizable manner. Users who can visually recognize the image data may be limited to the players of the game, or the image data may be widely and generally published.

Summoning of Employed Object

The system 4 causes the employed object employable by the player object to appear in accordance with the operation instruction of the player (step S307). For example, the employed object may battle with the enemy object instead of the player object, use the ability, or move with the player object riding on the employed object.

Equipping of Accessory Object

The system 4 equips the player object with the mountable accessory object in accordance with the operation instruction of the player (step S308). In a case where the player object is equipped with the accessory object, the system 4 changes a look of the player object displayed on the screen.

Simple Transfer

The system 4 may transfer the player object to the predetermined location in the region. In the second mode, unlike the first mode, the transfer may be able to be performed to the predetermined location in the region without determining the reaching condition. It is preferable that the location of the transfer destination is the location associated with the reaching condition or the location (for example, the entrance of the region) that improves convenience of the player.

The process in the progress of the game is not limited to the above process. Besides capturing, the action not related to the completion condition of the game, such as collecting the item, performing the geological survey, or cooking the ingredient, can be executed.

Completion Condition

For example, the completion condition of the game in the second mode is exemplified such that the predetermined enemy object in the region is defeated, the predetermined number of predetermined enemy objects are defeated, the predetermined quantity of predetermined items are collected, the predetermined item is obtained, or the predetermined position is reached.

In a case where the completion condition is satisfied, the system 4 finishes the second mode and finishes the search in the region.

The region of the second mode has approximately the same structure as the region of the first mode. It is preferable that a movable range of the player object in the region of the second mode includes the movable region in the region of the first mode. It is preferable that the region of the second mode is approximately the same as the region of the first mode in appearance within a range that may be visually recognized by the player.

A method of implementing the second mode is not particularly limited. For example, changing of the mode may be controlled by a program while the same region is used as the region of the first mode and the region of the second mode. Alternatively, the region of the second mode having the same structure as the region of the first mode may be separately prepared.

In the above example, while an example of not causing the enemy object to appear in the second mode is described, the embodiment of the present disclosure is not limited thereto. For example, a weak enemy object that can attack to only an extent that the player object does not receive damage may appear. That is, an enemy object weaker than the enemy object appearing under the first mode may appear.

In the above example, while an example of not validating the mechanism in the second mode is described, the embodiment of the present disclosure is not limited thereto. For example, the mechanism may be validated under the second mode in a simpler manner than under the first mode such that only a button for proceeding on a route is validated.

In the above example, while the reward is not granted in the second mode, the embodiment of the present disclosure is not limited thereto. For example, a reward corresponding to the degree of difficulty of the second mode may be granted.

In the above example, while the arranged object is arranged as a target of an action such as attack in the second mode, the embodiment of the present disclosure is not limited thereto. The action such as attack may be able to be executed even in a case where the target is not present.

In the above example, while the object attribute is changed in the second mode based on restriction of the object, the embodiment of the present disclosure is not limited thereto. For example, restriction of the object may be lifted, and any object may be able to participate in the region.

In the above example, while a time restriction or the like is not set, the embodiment of the present disclosure is not limited thereto. For example, play time of the second mode may be designed to be restricted in accordance with time taken until completion of the first mode.

In the above example, while any server apparatus to which the terminal apparatus operated by the player is connected in a case of matching is not specifically disclosed, for example, matching may be performed between player objects in the same server apparatus, or matching may be performed between different server apparatuses. Forming a party with a player object belongs to a different server apparatus may be allowed not only in matching but also in a case of forming the party in advance.

In the above example, while the MMORPG is exemplified as the game system as a game that can be synchronously played with other players, the embodiment of the present disclosure is not limited thereto. For example, the present disclosure can also be applied to a game in which the completion condition is set, and an action not directly related to the completion condition can be performed. The action not directly related to the completion condition may be an action that bothers other players. That is, the present disclosure may not be applied to a game that does not have a concept of other players and is executed by only a single player.

In the above example, while the server apparatus is used, the embodiment of the present disclosure is not limited thereto. For example, instead of a storage of the server apparatus, a distributed ledger used in the blockchain technology may be used.

In the above example, while the process is executed in the system, the embodiment of the present disclosure is not limited thereto. For example, design may be appropriately changed such that the server apparatus or the terminal apparatus executes the process.

As one aspect of the fourth embodiment, a new game system that increases the degree of freedom of the player and provides a higher degree of satisfaction can be provided.

As one aspect of the fourth embodiment, by including the capturing unit, the game system that can capture the image in the game at a preferred angle of view of the player and provides a higher degree of satisfaction and interest can be provided.

As one aspect of the fourth embodiment, by including the reward granting unit and performing the control as to whether or not to grant the reward in accordance with the mode of the game, a new game system that enables the player to select which mode to play and provides a high degree of freedom and a higher degree of satisfaction can be provided.

As one aspect of the fourth embodiment, by performing matching under the first mode and not performing matching under the second mode, a new game system that can cause the game to progress by a party desired by the player in the second mode and provides a high degree of freedom and a higher degree of satisfaction can be provided.

As one aspect of the fourth embodiment, by executing restriction of use of the item under the first mode and not executing restriction of use of the item under the second mode, a new game system that can cause the game to progress by using an item desired to be used by the player in the second mode and provides a high degree of freedom and a higher degree of satisfaction can be provided.

As one aspect of the fourth embodiment, by not allowing the object attribute to be changed under the first mode and allowing the object attribute to be changed under the second mode, a new game system that causes the player to be able to change the attribute of the object in the region in the second mode when desired and provides a high degree of freedom and a higher degree of satisfaction can be provided.

As one aspect of the fourth embodiment, by storing the attribute usable in the region in advance, the game system that can reduce a load related to a process of drawing the player object in the terminal apparatus and provides less stress and a high degree of satisfaction can be provided.

As one aspect of the fourth embodiment, by restricting the usable object under the first mode and not restricting the usable object under the second mode, a new game system that can cause the game to progress by using a desired player object of the player in the second mode and provides a high degree of freedom and a higher degree of satisfaction can be provided.

As one aspect of the fourth embodiment, by restricting use of the ability of the player object under the first mode and not restricting use of the ability under the second mode, a new game system that can cause the game to progress by using the ability at a desired timing of the player in the second mode and provides a high degree of freedom and a higher degree of satisfaction can be provided.

As one aspect of the fourth embodiment, by enabling the second mode to be played after the game under the first mode is completed, a new game system that can avoid repeated execution of the game under the same mode in a case of seizing the same region, reduces the stress of the player, and provides a higher degree of satisfaction can be provided.

As one aspect of the fourth embodiment, by causing the enemy object to appear under the first mode and not causing the enemy object to appear under the second mode, a new game system that facilitates seizing in the second mode compared to the first mode, reduces the stress of the player, and provides a higher degree of satisfaction can be provided.

As one aspect of the fourth embodiment, by not arranging the arranged object under the first mode and arranging the arranged object under the second mode, a new game system that enables the action of the player object to be easily checked in the second mode and provides a higher degree of satisfaction can be provided.

As one aspect of the fourth embodiment, by validating the mechanism under the first mode and not validating the mechanism under the second mode, a new game system that facilitates seizing in the second mode compared to the first mode, reduces the stress of the player, and provides a higher degree of satisfaction can be provided.

As one aspect of the fourth embodiment, by transmitting the captured image data to another server apparatus, the game system that causes a person not playing the game to be interested in the game by sharing a status of the game to the person and provides higher interest can be provided.

Contents disclosed in the first embodiment can be employed as necessary for each of the “terminal apparatus”, the “server apparatus”, the “region”, the “degree of difficulty”, the “lower degree of difficulty”, and “enabling execution” in the fourth embodiment. Contents disclosed in the second embodiment can be employed as necessary for each of the “image in the game” and the “image”. Contents disclosed in the third embodiment can be employed as necessary for the “reward”.

In the fourth embodiment, for example, the “object” is an object present in the game space and may be visible or not visible. The player object, the enemy object, and the arranged object are concepts included in the object. For example, the “item” refers to a tool or a weapon usable in the game. For example, the “item attribute” refers to the attribute of the item and, more specifically, is exemplified by the level, the degree of training, or the durability.

In the fourth embodiment for example, the “object attribute” refers to the attribute of the object and, more specifically, is exemplified by the level, the job, the status, or the ability. For example, the “ability” generates an effect in a case where the ability is used in the game, and is different from the item. More specifically, the ability generates an effect of attack, defense, recovery, buff, and debuff in the region.

In the fourth embodiment, for example, the “mechanism” hinders the progress of the game for the player.

### APPENDIX

The above embodiments have been described such that the following disclosure can be embodied by those who have ordinary knowledge in the field to which the disclosure belongs.

(1) A game program executed in a server apparatus of a game system including one or more terminal apparatuses operated by a player and the server apparatus connectable to the terminal apparatus by communication, the game program causing the server apparatus to function as first progress means for progressing a game under a first mode in a predetermined region in the game, second mode enabling means for enabling execution of a second mode in a case where a predetermined second mode execution condition for executing the second mode having a lower degree of difficulty than the first mode is satisfied, and second progress means for progressing the game under the second mode in the predetermined region.

(2) The game program according to (1), further causing the server apparatus to function as capturing means for capturing an image in the game based on an operation instruction of the player.

(3) The game program according to (1) or (2), further causing the server apparatus to function as reward granting means for granting a reward to the player in a case where a predetermined reward granting condition is satisfied, in which under the first mode, the reward is granted by the reward granting means, and under the second mode, the reward is not granted by the reward granting means.

(4) The game program according to any one of (1) to (3), further causing the server apparatus to function as matching means for performing a matching process between objects operable by the player, in which under the first mode, the game progresses by performing the matching process and forming a group of objects, and under the second mode, the game progresses without performing the matching process.

(5) The game program according to any one of (1) to (4), in which a predetermined attribute is set for an item usable in the game, the game program further causes the server apparatus to function as item restriction means for restricting use of the item in a case where the predetermined attribute related to the item does not satisfy a predetermined item use condition, under the first mode, use of the item is restricted by the item restriction means, and under the second mode, use of the item is not restricted by the item restriction means.

(6) The game program according to any one of (1) to (5), in which a predetermined attribute is set for an object operable by the player, the game program further causes the server apparatus to function as object attribute changing means for changing from the predetermined attribute related to the object to another predetermined attribute, under the first mode, a control for not allowing changing of an attribute related to the object by the object attribute changing means is performed, and under the second mode, a control for allowing changing of the attribute related to the object by the object attribute changing means is performed.

(7) The game program according to (6), further causing the server apparatus to function as usable attribute storage means for storing, in association with a region in the game, an attribute related to an object usable in the region, in which the object attribute changing means changes to the attribute related to the object usable in the region corresponding to a position of the object.

(8) The game program according to any one of (1) to (7), in which a predetermined attribute is set for an object operable by the player, the game program further causes the server apparatus to function as object restriction means for restricting use of the object in a case where the predetermined attribute related to the object does not satisfy a predetermined object use condition, under the first mode, use of the object is restricted by the object restriction means, and under the second mode, use of the object is not restricted by the object restriction means.

(9) The game program according to any one of (1) to (8), in which an ability usable in the game is set for an object operable by the player, the game program further causes the server apparatus to function as ability use restriction means for restricting use of the ability in a case where a predetermined ability use condition is not satisfied, under the first mode, use of the ability is restricted by the ability use restriction means, and under the second mode, use of the ability is not restricted by the ability use restriction means.

(10) The game program according to any one of (1) to (9), in which the second mode execution condition is completing the game under the first mode by the first progress means, and the second mode enabling means enables execution of the second mode in a predetermined region in which the game under the first mode is completed.

(11) The game program according to any one of (1) to (10), in which the game is a game in which a virtual battle is performed between an object operable by the player and an enemy object, the game program further causes the server apparatus to function as enemy object control means for causing the enemy object to appear in the game, under the first mode, a control for causing the enemy object to appear in the game by the enemy object control means is performed, and under the second mode, a control for not causing the enemy object to appear in the game by the enemy object control means is performed.

(12) The game program according to any one of (1) to (11), further causing the server apparatus to function as object arrangement means for arranging an arranged object that is a target on which an object operable by the player executes a predetermined action, in which under the first mode, a control for not arranging the arranged object in the game by the object arrangement means is performed, and under the second mode, a control for arranging the arranged object in the game by the object arrangement means is performed.

(13) The game program according to any one of (1) to (12), in which the game is a game in which a mechanism that hinders movement of an object operable by the player is settable, the game program further causes the server apparatus to function as mechanism validation means for validating the set mechanism, under the first mode, a control for validating the set mechanism by the mechanism validation means is performed, and under the second mode, a control for not validating the set mechanism by the mechanism validation means is performed.

(14) The game program according to (2), further causing the server apparatus to function as image data transmission means for transmitting image data captured by the capturing means to another server apparatus.

(15) A server apparatus on which the game program according to any one of (1) to (14) is installed.

(16) A game system including one or more terminal apparatuses operated by a player and a server apparatus connectable to the terminal apparatus by communication, the game system including first progress means for progressing a game under a first mode in a predetermined region in the game, second mode enabling means for enabling execution of a second mode in a case where a predetermined second mode execution condition for executing the second mode having a lower degree of difficulty than the first mode is satisfied, and second progress means for progressing the game under the second mode in the predetermined region.

(17) A game program executed in a terminal apparatus of a game system including one or more terminal apparatuses operated by a player and a server apparatus connectable to the terminal apparatus by communication, the game program causing the terminal apparatus to function as first progress means for progressing a game under a first mode in a predetermined region in the game, second mode enabling means for enabling execution of a second mode in a case where a predetermined second mode execution condition for executing the second mode having a lower degree of difficulty than the first mode is satisfied, and second progress means for progressing the game under the second mode in the predetermined region.

(18) A terminal apparatus on which the game program according to (17) is installed.

(19) A game control method executed in a server apparatus of a game system including one or more terminal apparatuses operated by a player and the server apparatus connectable to the terminal apparatus by communication, the game control method including progressing a game under a first mode in a predetermined region in the game, enabling execution of a second mode in a case where a predetermined second mode execution condition for executing the second mode having a lower degree of difficulty than the first mode is satisfied, and progressing the game under the second mode in the predetermined region.

(20) A game control method executed in a game system including one or more terminal apparatuses operated by a player and a server apparatus connectable to the terminal apparatus by communication, the game control method including progressing a game under a first mode in a predetermined region in the game, enabling execution of a second mode in a case where a predetermined second mode execution condition for executing the second mode having a lower degree of difficulty than the first mode is satisfied, and progressing the game under the second mode in the predetermined region.

### REFERENCE SIGNS LIST

1 SERVER APPARATUS
2 COMMUNICATION NETWORK
3 TERMINAL APPARATUS
4 SYSTEM

1. A non-transitory computer-readable recording medium having recorded thereon a game program executed in a server apparatus of a game system, the game program causing the server apparatus to perform functions comprising:
communicating with one or more terminal apparatuses in the game system operated by a player of the game;
progressing a game under a first mode in a predetermined region in the game;
enabling execution of a second mode, if a predetermined second mode execution condition for executing the second mode having a lower degree of difficulty than the first mode is satisfied; and
progressing the game under the second mode in the predetermined region.

2. The non-transitory computer-readable recording medium having recorded thereon the game program according to claim 1, the functions further comprising:
capturing an image in the game based on an operation instruction of the player.

3. The non-transitory computer-readable recording medium having recorded thereon the game program according to claim 2, the functions further comprising:
transmitting the captured image data to another server apparatus.

4. The non-transitory computer-readable recording medium having recorded thereon the game program according to claim 1, the functions further comprising:
granting a reward to the player if a predetermined reward granting condition is satisfied under the first mode; and; and
disabling granting the reward to the player if the predetermined reward granting condition is satisfied under the second mode.

5. The non-transitory computer-readable recording medium having recorded thereon the game program according to claim 1, the functions further comprising:
performing a matching process between objects configured to be operated by the player under the first mode and forming a group of objects under the first mode; and
progressing the game while disabling the matching process under the second mode

6. The non-transitory computer-readable recording medium having recorded thereon the game program according to claim 1, wherein a predetermined attribute is set for an item configured to be used in the game, the functions further comprising:
restricting use of the item if the predetermined attribute related to the item does not satisfy a predetermined item use condition under the first mode; and
under the second mode, allowing use of the item.

7. The non-transitory computer-readable recording medium having recorded thereon the game program according to claim 1, wherein a predetermined attribute is set for an object configured to be operated by the player, the functions further comprising:
allowing changing from the predetermined attribute related to the object to another predetermined attribute under the second mode; and
disallowing changing from the predetermined attribute related to the object to another predetermined attribute under the first mode.

8. The non-transitory computer-readable recording medium having recorded thereon the game program according to claim 7, the functions further comprising:
storing, an attribute related to an object configured to be used in a region in the game in association with the game,
wherein the predetermined attribute related to the object is configured to be changed to the attribute related to the object configured to be used in the region corresponding to a position of the object.

9. The non-transitory computer-readable recording medium having recorded thereon the game program according to claim 1, wherein a predetermined attribute is set for an object configured to be operated by the player, the functions further comprising:
restricting use of the object if the predetermined attribute related to the object does not satisfy a predetermined object use condition under the first mode; and
under the second mode, allowing use of the object.

10. The non-transitory computer-readable recording medium having recorded thereon the game program according to claim 1, in which an ability usable in the game is set for an object configured to be used by the player, the functions further comprising:
restricting use of the ability if a predetermined ability use condition is not satisfied under the first mode; and
under the second mode, allowing use of the ability.

11. The non-transitory computer-readable recording medium having recorded thereon the game program according to claim 1,
wherein the second mode execution condition is completing the game under the first mode, and
the second mode is enabled in a predetermined region where the game under the first mode is completed.

12. The non-transitory computer-readable recording medium having recorded thereon the game program according to claim 1, in which the game is a game in which a virtual battle is performed between an object configured to be used by the player and an enemy object, the functions further comprising:
causing the enemy object to appear in the game under the first mode; and
under the second mode, disabling causing the enemy object to appear in the game.

13. The non-transitory computer-readable recording medium having recorded thereon the game program according to claim 1, the functions further comprising:
arranging an arranged object that is a target on which an object configured to be used by the player executes a predetermined action under the second mode; and
under the first mode, disabling arranging the arranged object in the game is performed.

14. The non-transitory computer-readable recording medium having recorded thereon the game program according to claim 1, in which the game is a game in which a mechanism that hinders movement of an object configured to be used by the player is settable, the functions further comprising:
validating the set mechanism, under the first mode, a control for validating the set mechanism is performed; and
under the second mode, disabling validating the set mechanism is performed.
$$performed .$$

15. A game system comprising:
one or more terminal apparatuses configured to be operated by a player;
a server apparatus configured to communicate with the terminal apparatuses; and
a computer configured to:
progress a game under a first mode in a predetermined region in the game;
enable execution of a second mode if a predetermined second mode execution condition for executing the second mode having a lower degree of difficulty than the first mode is satisfied; and
progress the game under the second mode in the predetermined region.

16. A non-transitory computer-readable recording medium having recorded thereon a game program executed in a terminal apparatus of a game system configured to be operated by a player, the game program causing the terminal apparatus to perform functions comprising:
communicating with a server apparatus in the game system;
progressing a game under a first mode in a predetermined region in the game;
enabling execution of a second mode in a case where a predetermined second mode execution condition for executing the second mode having a lower degree of difficulty than the first mode is satisfied; and
progressing the game under the second mode in the predetermined region.
